(19) United States
(12) Patent Application Publication
(10) Pub. No.: US 2026/0288461 A1
(43) Pub. Date: Sep. 24, 2026

(54) PREDICTION ENTRY ALLOCATION

(71) Applicant: Arm Limited, Cambridge (GB)

(72) Inventors: Houdhaifa BOUZGUARROU, Valbonne (FR); Michael Brian SCHINZLER, Round Rock, TX (US); Sergio SCHULER, Austin, TX (US); Anand Sunder RAJAN, Austin, TX (US)

(21) Appl. No.: 19/083,998

(22) Filed: Mar. 19, 2025

(51) Int. Cl. G06F 9/30; G06F 1/03; G06F 9/38

(52) U.S. Cl. CPC G06F 9/3005; G06F 1/03; G06F 9/3802; G06F 9/3842

(57) ABSTRACT

There is provided an apparatus comprising training circuitry to store one or more metrics associated with each of a plurality of control flow altering instructions, and a plurality of candidate multi-taken entries. Each candidate multi-taken entry identifies: a multi-taken sequence in which control flow is diverted by a first control flow altering instruction to instructions comprising a second control flow altering instruction that diverts control flow to a target address, and metadata indicative of a confidence associated with the candidate multi-taken sequence. The apparatus comprises control circuitry responsive to the confidence associated with a given candidate multi-taken entry satisfying a confidence condition and the metrics associated with at least one of the first and second control flow altering instructions of the given candidate multi-taken entry satisfying a filter condition, to allocate a prediction entry indicative of the multi-taken sequence identified in the given candidate multi-taken entry into prediction circuitry.

### TECHNICAL FIELD

The present invention relates to data processing. More particularly the present invention relates to an apparatus, a system, a chip-containing product, a method, and a computer-readable medium.

### BACKGROUND

Some apparatuses are provided with prediction circuitry configured to predict control flow based on prediction entries.

### SUMMARY

According to a first aspect of the present techniques there is provided an apparatus comprising:
training circuitry configured to store one or more metrics associated with each of a plurality of control flow altering instructions, and a plurality of candidate multi-taken entries, each of the candidate multi-taken entries identifying:
   a multi-taken sequence of instructions in which control flow is diverted by a first control flow altering instruction to a series of instructions comprising a second control flow altering instruction that diverts control flow to a target address; and
   metadata indicative of a confidence associated with the candidate multi-taken sequence; and
control circuitry responsive to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, to allocate a prediction entry indicative of the multi-taken sequence identified in the given candidate multi-taken entry into prediction circuitry configured to predict control flow based on the prediction entry.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method comprising:
storing, in training circuitry, one or more metrics associated with each of a plurality of control flow altering instructions, and a plurality of candidate multi-taken entries, each of the candidate multi-taken entries identifying:
   a multi-taken sequence of instructions in which control flow is diverted by a first control flow altering instruction to a series of instructions comprising a second control flow altering instruction that diverts control flow to a target address; and
   metadata indicative of a confidence associated with the candidate multi-taken sequence; and
in response to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, allocating a prediction entry indicative of the multi-taken sequence identified in the given candidate multi-taken entry into prediction circuitry configured to predict control flow based on the prediction entry.

According to a fifth aspect of the present techniques there is provided a non-transitory computer-readable medium storing computer-readable code for fabrication of an apparatus comprising:
training circuitry configured to store one or more metrics associated with each of a plurality of control flow altering instructions, and a plurality of candidate multi-taken entries, each of the candidate multi-taken entries identifying:
   a multi-taken sequence of instructions in which control flow is diverted by a first control flow altering instruction to a series of instructions comprising a second control flow altering instruction that diverts control flow to a target address; and
   metadata indicative of a confidence associated with the candidate multi-taken sequence; and
control circuitry responsive to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, to allocate a prediction entry indicative of the multi-taken sequence identified in the given candidate multi-taken entry into prediction circuitry configured to predict control flow based on the prediction entry.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an example multi-taken sequence according to some configurations of the present techniques;

FIG. 4 schematically illustrates an example multi-taken sequence according to some configurations of the present techniques;

FIG. 5 schematically illustrates an apparatus according to some configurations of the present techniques;

FIG. 6 schematically illustrates metadata according to some configurations of the present techniques;

FIG. 7 schematically illustrates triggering allocation in prediction circuitry according to some configurations of the present techniques;

FIG. 8 schematically illustrates an apparatus according to some configurations of the present techniques;

FIG. 9 schematically illustrates triggering allocation in prediction circuitry according to some configurations of the present techniques;

FIG. 10 schematically illustrates a sequence of steps carried out according to some configurations of the present techniques; and

FIG. 11 schematically illustrates a system and a chip containing product according to some configurations of the present techniques.

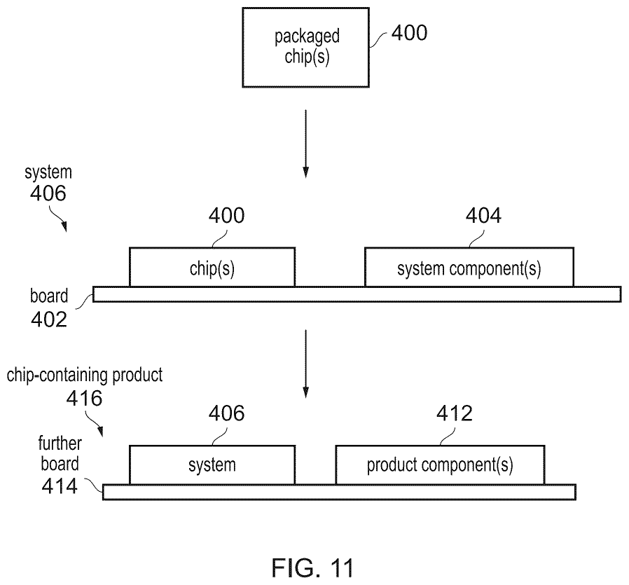

### DESCRIPTION OF EXAMPLE CONFIGURATIONS

Before discussing the configurations with reference to the accompanying figures, the following description of configurations is provided.

In accordance with one example configuration there is provided apparatus comprising training circuitry configured to store one or more metrics associated with each of a plurality of control flow altering instructions, and a plurality of candidate multi-taken entries. Each of the candidate multi-taken entries identifies: a multi-taken sequence of instructions in which control flow is diverted by a first control flow altering instruction to a series of instructions comprising a second control flow altering instruction that diverts control flow to a target address, and metadata indicative of a confidence associated with the candidate multi-taken sequence. The apparatus is provided with control circuitry responsive to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, to allocate a prediction entry indicative of the multi-taken sequence identified in the given candidate multi-taken entry into prediction circuitry configured to predict control flow based on the prediction entry.

Prediction of an outcome of control flow altering instructions (e.g., conditional branch instructions or unconditional branch instructions) can involve the following stages:
1. For a given program counter address X identifying a block of one or more instructions, predict an instruction address X1 identifying a first control flow altering instruction (e.g., a conditional branch instruction or a non-conditional branch instruction) in the given block of instructions;
2. Predict the direction for the control flow altering instruction located at address X1, i.e., predict whether the control flow altering instruction will be taken or not taken;
3. If the control flow changing instruction is predicted as taken, then predict the target address, PC=Y, of the predicted control flow changing instruction; and
4. Populate a fetch queue with instruction addresses based on the outcome of predictions 1 to 3 to include instructions, from the block of instructions identified by program counter address X, and update the program counter for the next prediction based on the outcome of the predictions.

Such a prediction cycle enables a fetch queue, configured to identify instructions to be fetched for execution, to be updated to incorporate instruction addresses from one block of instructions per cycle and may be triggered, for example, through an entry in prediction entry storage identifying a predicted outcome for a single branch instruction.

For general control flow altering instructions, i.e., single control flow altering instructions for which a single outcome needs to be predicted, prediction circuitry configured to predict the outcome of a control flow altering instruction can populate the fetch queue based on a single observation of that single control flow altering instruction. The apparatus according to the present techniques is configured to support multi-taken sequences. A multi-taken sequence comprises a first branch instruction comprised in a first instruction block and a second branch instruction comprised in a second instruction block with the second instruction block being the target of the first branch instruction. The identification of a multi-taken sequence in the prediction circuitry therefore enables a prediction to be made that identifies an outcome of a first branch instruction and a second branch instruction that are expected to occur during program execution and, where a multi-taken entry is identified, and the first branch instruction is predicted to be taken, the control circuitry can populate the fetch queue based on the outcome of both of the first and second branch instructions, thereby increasing the rate at which the fetch queue can be populated.

Whilst multi-taken entries can result in an increased rate at which the fetch queue can be populated, there are additional difficulties to overcome in relation to some use cases of the multi-taken entries. The presence of a multi-taken entry in the prediction circuitry can, in some use cases, have potentially detrimental effects. For example, where a multi-taken entry is mispredicted the number of clock cycles required to correct for the misprediction and/or the amount of additional power required to recover from the misprediction may be larger than a case in which an outcome of a single branch instruction is mispredicted. Hence, there may be use cases in which it is beneficial to allow the individual branches that make up a multi-taken sequence to be individually predicted, for example, as a result of two separate entries in the prediction circuitry.

A multi-taken entry is therefore not entered in prediction circuitry based on a single observation of a particular multi-taken sequence. Instead, the apparatus is provided with training circuitry that is arranged to store a plurality of candidate multi-taken entries. Each candidate multi-taken entry is provided to identify a multi-taken sequence and metadata indicating a confidence associated with that sequence. The candidate multi-taken entries do not need to store all the particulars of the multi-taken sequence and need only store sufficient information to identify a particular multi-taken sequence so that a repeated occurrence of the multi-taken sequence can be identified and the confidence associated with that multi-taken sequence can be updated based on the repeated observation. For example, the candidate multi-taken entry may identify the multi taken sequence based on a pair of program counter values identifying addresses of the first and second control flow altering instructions. Alternatively, the candidate multi-taken entry may be identified based on a single program counter base address and a pair of offsets, each indicative of one of the first and second control flow altering instructions.

The inventors have recognised that, whilst allocating prediction entries into the prediction circuitry to enable the prediction circuitry to predict control flow based on that entry could be performed based on the confidence value, there are use cases in which a multi-taken sequence may reach a sufficient confidence level and still result in mispredictions, for example, due to the presence of a branch instruction that is strongly history dependent or that operates in a manner that is easy to predict some of the time (e.g., where the branch instruction is accessed based on a first portion of a program or where the outcome is based on a first, predictable, set of circumstances) and that is difficult to predict at other times (e.g., where the branch instruction is accessed based on a second portion of a program or where the outcome is based on a second, less predictable, set of circumstances). The training circuitry is therefore configured to store one or more metrics associated with a plurality of control flow altering instructions. The plurality of control flow altering instructions may include all control flow altering instructions observed, e.g., over an instruction window, or a subset of control flow altering instructions which meet one or more suitability conditions for being included in a multi-taken sequence. The first and second control flow altering instructions in each of the multi-taken sequences may be instructions of the plurality of control flow altering instructions stored in the training circuitry. In some use cases multiple multi-taken sequences may be associated with a same control flow altering instruction. For example, where a second control flow altering instruction in two or more multi-taken sequences may be reached (e.g., branched to) from multiple points in a sequence of instructions and, hence, that second control flow altering instruction may be included in each of the two or more multi-taken sequences. The apparatus is also provided with control circuitry that is configured to identify multi-taken sequences for which both the confidence associated with a given multi-taken entry satisfies a confidence condition, and one or more metrics identified in the metadata associated one or more of the control flow altering instructions identified in association the given multi-taken entry satisfy a filter condition. In some configurations the control circuitry may only require that the one or more metrics associated with the second control flow altering instruction satisfy the filter condition. In other configurations the control circuitry may require that the one or more metrics associated with both control flow altering instructions satisfy the filter condition or that different filter conditions are satisfied by each of the first control flow altering instruction and the second control flow altering instruction. The control circuitry is responsive to identification of a given multi-taken sequence for which both the conditions (i.e., the confidence condition and the filter condition) are satisfied to allocate the prediction entry into the prediction circuitry. As used herein the confidence associated with a candidate multi-taken sequence is a value indicative of a likelihood that an outcome of each of the first control flow altering instruction and the second control flow altering instruction of the candidate multi-taken sequence will follow a predictable pattern, i.e., that a prediction for that candidate multi-taken sequence would have been accurate. For example, the confidence may be provided by a counter that is incremented when the outcome of the candidate multi-taken sequence progresses as predicted and that is otherwise decreased. The confidence may be identified as satisfying the confidence condition when the confidence reaches a threshold value. The provision of the filter condition in combination with the one or more metrics enables additional information to be incorporated into the decision of which candidate multi-taken entries are to be used for prediction of control flow. In particular, the decision as to whether a candidate multi-taken entry is allocated for prediction is based on both the overall performance of the candidate multi-taken entry and the individual one or more metrics associated with at least one of the branch instructions that comprise the multi-taken entry. This provides improved flexibility and increases the likelihood that candidate multi-taken entries that will benefit the overall rate of instruction throughput can be allocated in the prediction circuitry.

In some configurations the one or more metrics comprise information other than the confidence. In other words, the one or more metrics are associated with information other than an accuracy of the rate of predictions that may be made in association with the candidate multi-taken sequence. In some configurations the one or more metrics are associated with information other than a misprediction rate of one or more of the control flow altering instructions in the candidate multi-taken sequence.

The one or more metrics may comprise different types of metrics, for example, in some configurations the one or more metrics comprise at least one exclusive metric, and the control circuitry is responsive to the at least one exclusive metric associated with at least one of the first control flow altering instruction and the second control flow altering instruction of the given candidate multi-taken entry meeting an exclusion condition, to exclude the given candidate multi-taken sequence from allocation into the prediction circuitry. The at least one exclusive metric may comprise a binary exclusive metric with the exclusion condition excluding candidate multi-taken sequences for which a condition is true for at least one of the first control flow altering instruction and the second control flow altering instruction associated with that candidate multi-taken sequence. Alternatively, or in addition, the at least one exclusive metric may comprise an exclusive counter metric in which a counter is incremented in response to one or more events and when the counter exceeds a threshold, candidate multi-taken sequences associated with at least one of the first control flow altering instruction and the second control flow altering instruction for which that counter metric exceeds the threshold are excluded from allocation into the prediction circuitry.

In some configurations the training circuitry is configured to store the one or more metrics in a plurality of fields, and the control circuitry is configured to calculate whether the filter condition is satisfied based on a combination of the plurality of fields. The combination may take into account all fields of the plurality of fields. Alternatively, the combination may take into account a subset of the plurality of fields.

Whilst the combination may be fixed, for example, hardwired into circuitry, in some configurations the combination of the plurality of fields is dynamically configurable. The combination may be provided as a default value that can be modified, for example, by higher privileged software such as an operating system or hypervisor, by setting a flag in a control register. Where the flag takes a first value, the default condition may be used. Where the flag takes a second value, different from the first value, an alternative condition, for example, as defined by one or more control registers may be used. Alternatively, the combination may be dynamically updated based on one or more runtime conditions, for example, a counter may be provided indicative of a prediction accuracy of multi-taken entries allocated into the prediction circuitry. Where the counter indicates a high level of accuracy (for example, an accuracy greater than an accuracy threshold) the combination may be modified to reduce the threshold for candidate multi-taken entries to be allocated into the prediction circuitry. On the other hand, where the counter indicates a low level of accuracy (for example, the accuracy is not greater than the accuracy threshold) the combination may be modified to increase the threshold for candidate multi-taken entries to be allocated into the prediction circuitry.

In some configurations the combination comprises at least one of: an arithmetic combination of the plurality of fields; and a logical combination of the plurality of fields. The combination may be a based on a linear or non-linear combination of the plurality of fields and/or may make use of any logical combination of the fields.

Whilst some fields may be provided that can only change monotonically, for example some fields may only increment in response to observation of an event, in some configurations at least one of the plurality of fields is configured to increment in response to a first event and to decrement in response to a second event. In some configurations one of the plurality of fields other than the confidence may be configured to increment in response to a first event and to decrement in response to a second event. The first event and the second event may be related to one another. For example, the first event may indicate a positive outcome of a binary decision, i.e., a requirement is met or a determination is found to be true, and the second event may indicate a negative outcome of the binary decision, i.e., the requirement is not met or the determination is found to be false. Alternatively, the first event and the second event may be unrelated to one another with the at least one of the plurality of fields being incremented or decremented in response to different conditions being met. The amount by which the field is configured to increment or decrement may be equal and opposite, i.e., the increment is an increment by an amount and the decrement is a decrement by the (same) amount. Alternatively, the increment and the decrement may take different values with the increment being an increment of a first amount and the decrement being a decrement of a second amount different from the first amount.

In some configurations the training circuitry is configured to store the one or more metrics in a combined metric field indicative of a combination of the one or more metrics. Rather than storing each of the one or more metrics individually for each of the plurality of control flow altering instructions, the combined metadata field may be provided to indicate an overall trend in the one or more metrics. This approach requires less space to be allocated to the one or more metrics for each of the plurality of control flow altering instructions.

For example, in some configurations the combined metric field is a global metric field; and the training circuitry is configured to update the global metric field in response to a change in each of the one or more metrics. In other words, rather than storing each of the one or more metrics for each of the plurality of control flow altering instructions and then, subsequently, calculating whether the filter condition has been satisfied for a given one of the control flow altering instructions based on the combination of the one or more metrics, the global metadata field stored in association with each of the plurality of control flow altering instructions may be modified each time one of the one or more metrics changes for that control flow altering instruction and, subsequently, it can be determined whether the filter condition is satisfied by applying a threshold to the global metric.

In some configurations the training circuitry table is configured to store a plurality of weights, each of the plurality of weights associated with one of the one or more metrics; and the training circuitry is responsive to a given event corresponding to one of the one or more metrics of an associated control flow altering instruction, to select a given weight associated with the given event from the plurality of weights, and to modify the combined metric field of the associated control flow altering instruction by an amount indicated by the given weight. The plurality of weights, which include the given weight, may comprise hard wired weights and/or dynamically modifiable weights. The dynamically modifiable weights may be modifiable by higher privileged code such as an operating system or a hypervisor executing code on the apparatus. As discussed, the different weights may be provided with a first weight for an increment/decrement, in response to an occurrence of the given event in association with observation of the multi-taken sequence in and a second weight in response to a decrement/increment in response to the given event not occurring in association with observation of the multi-taken sequence.

The combined metric field may be provided in addition to the confidence. Alternatively, in some configurations, the combined metric field is indicative of the confidence. In other words, rather than providing the confidence and the combined metric field as two separate fields in the training circuitry, in some configurations, these fields may be combined with one another. For example, where one or more metrics indicate that a control flow altering instruction associated with a candidate multi-taken sequence is less likely to be useful, a greater confidence may be required than a case in which the one or more metrics indicate that the control flow altering instruction associated with the candidate multi-taken sequence is more likely to be useful.

Whilst the metrics may be indicative of any features of the apparatus, in some configurations the one or more metrics comprises at least one prediction structure metric indicative of a type of prediction structure used to determine control flow resulting from an associated control flow altering instruction. The prediction structures provided to an apparatus may comprise a plurality of different types of prediction structures including, for example, one or more types of TAgged GEometric (TAGE) prediction structures that predict an outcome of a branch instruction based on a history (e.g., a global history) of recently executed branch instructions. Alternatively, or in addition, the prediction structures may include one or more perceptron based predictors, one or more counter based prediction structures (for example, based on a 1-bit or a 2-bit saturating counter), one or more replay predictors that identify an outcome of a branch based during a replay of a particular segment of code, and/or one or more random branch predictors. Dependent on the use case of an individual branch instruction, different predictors may perform with different degrees of accuracy. Branches that are easier to predict, for example, because they typically follow an easy to predict pattern, may be accurately predicted by simpler branch prediction structures. On the other hand, branches that are difficult to predict, for example, because they are history or data dependent, may require a more complex branch prediction structure in order to obtain an accurate prediction. The inventors have recognised that candidate multi-taken sequences in which one of the instructions is harder to predict, may be less well suited to being allocated as a multi-taken entry in the prediction circuitry. Hence, the provision of a prediction structure metric indicative of the type of prediction structure used to determine control flow resulting from control flow altering instructions associated with the candidate multi-taken entry can be useful to filter out candidate multi-taken entries that would be less beneficial when allocated to the candidate multi-taken entry.

Alternatively, or in addition, in some configurations the one or more metrics comprises at least one prediction accuracy metric indicative of a misprediction rate associated with an associated control flow altering instruction. The confidence stored in association with the candidate multi-taken entry may not always accurately represent the likelihood that the candidate multi-taken entry will be accurately predicted. For example, in some use cases, a control flow altering instruction associated with a candidate multi-taken entry may have a low overall accuracy (a high misprediction rate), but the candidate multi-taken sequence may reach a high confidence value if that candidate multi-taken entry happens to be accurately predicted multiple times in a row (e.g., through random chance or because of a particular application of a section of code to a particular set of data). The inventors have recognised that, the confidence associated with the multi-taken sequence on its own may not be sufficient to identify when a candidate multi-taken entry will perform well. On the other hand, the misprediction rate for the control flow altering instructions associated with the candidate multi-taken entry may provide a better picture of whether the candidate multi-taken entry will result in a large number of mispredictions and, hence, can be used to filter out candidate multi-taken entries to prevent those candidate multi-taken entries from being allocated into the prediction circuitry.

In addition to, or as an alternative to, the provision, within the one or more metrics, of one or more counters that increment or decrement in response to changes in the one or more metrics or that indicate the one or more metrics, in some configurations the one or more metrics comprises one or more persistent fields, each of the one or more persistent fields associated with a different one of the one or more metrics; and the training circuitry is responsive to a given metric of the one or more metrics meeting a predefined condition, to set the persistent field associated with the given metric. Where a given candidate multi-taken entry performs particularly poorly, for example, has a high misprediction rate, or requires a particular prediction circuit in order to accurately predict the outcome of the one of the control flow altering instructions associated with the given candidate multi-taken entry, one of the one or more persistent fields may be set to indicate to the control circuitry that the given candidate multi-taken entry should not be allocated to the prediction circuitry regardless of how well that candidate multi-taken entry subsequently performs. For example, where one of the control flow altering instructions associated with a candidate multi-taken entry results in a set of mispredictions, a persistent bit associated with that control flow altering instruction may be set so that, even if the control flow altering instruction and the associated candidate multi-taken entry goes on to behave in a predictable way, e.g., due to a change in the use case, the persistent bit indicates to the control circuitry that there are observed use cases for which the control flow altering instruction associated with that candidate multi-taken entry will result in a high rate of mispredictions and that, if the candidate multi-taken entry were to be allocated into the prediction circuitry then (regardless of how well any other metrics of the one or more metrics are performing or how high the confidence is), there is a potential that the candidate multi-taken entry could be detrimental to the overall performance. Therefore, by providing the one or more persistent fields, the control circuitry is able to more accurately select suitable multi-taken entries to be allocated in the prediction circuitry.

In some configurations the training circuitry is configured to maintain a set value of the one or more persistent fields throughout a training window having a predefined training window duration. The predefined training window duration may last for a predefined number of clock cycles, a predefined number of training instructions, a predefined number of instruction blocks, or until a region of memory in which the first and second control flow altering instructions are stored is removed from a region table indicative of regions of memory that are being actively used by the processing circuitry. The predefined training window may be a relatively long training window, for example, lasting for thousands or tens of thousands of cycles/training instructions.

In some configurations the apparatus comprises a fetch queue configured to identify a sequence of instructions to be fetched for execution; and the prediction circuitry, wherein the prediction circuitry is configured to store a plurality of prediction entries, and in response to receipt of an instruction address, to perform a lookup in the prediction storage circuitry based on the instruction address, and when the lookup results in a hit on a given entry in the prediction storage circuitry, to perform a prediction of upcoming control flow based on the given entry and to control which instructions are identified in the fetch queue in dependence on the prediction. For example, the prediction circuitry may comprise a Branch Target Buffer (BTB) configured to store the prediction entries for both standard control flow altering instructions (branch instructions), and for multi-taken sequences of control flow altering instructions. In the event that a misprediction occurs the apparatus may be provided with one or more mechanisms to correct the instruction addresses identified in the fetch queue, for example, by storing one or more additional instruction addresses and prediction data associated with instructions that, according to the prediction, are not incorporated in the fetch queue. In the event that the prediction is then determined to be incorrect, the instructions resulting from the incorrect prediction can be flushed from the fetch queue and the stored instruction addresses can be used to repopulate the fetch queue without having to rerun the prediction cycle for that block of instructions. The prediction circuitry of the present invention is configured to support multi-taken entries. The multi-taken entry enables a prediction to be made that identifies an outcome of a first branch instruction and a second branch instruction that are expected to occur during program execution and, where a multi-taken entry is identified in the prediction storage, and the first branch instruction is predicted to be taken, the control circuitry can populate the fetch queue based on the outcome of both of the first and second branch instructions, thereby increasing the rate at which the fetch queue can be populated. In general, a multi-taken entry is stored for cases in which it is more likely that at least the first branch instruction will be taken than not-taken. However, this does not have to be the case and, for a given instance of a prediction being made based on a multi-taken entry, either the first branch instruction and/or the second branch instruction may be predicted as not-taken. In the event that the first branch instruction is predicted as not-taken any prediction made in relation to the second branch instruction may be discarded or stored for subsequent use in the event that the first branch instruction has been mispredicted, and the fetch queue may be populated based only on the first branch prediction (because, according to the prediction, control flow would not be diverted to the second branch instruction). However, when the first branch instruction is predicted as taken, the fetch queue is populated based on both of the first branch instruction and the second branch instruction. For example, the fetch queue may be populated with instructions from the first block of instructions up to and including the first branch instruction, and instructions from the second block of instructions. The instructions included in the fetch queue from the second block of instructions is dependent on the predicted outcome of the second branch instruction. Where the second branch instruction is predicted as taken, the fetch queue would be populated with instruction addresses from the second block up to and including the second branch instruction address but not including instruction addresses subsequent to the second branch instruction address. Where the second branch instruction is predicted as not-taken, the fetch queue would be populated with instruction addresses from the second block of instructions including at least some of any instructions that occur sequentially after the second branch instruction (e.g., instructions that occur after the second branch instruction but before any other branch instructions predicted to occur in the second block of instructions). Hence, a misprediction of a multi-taken sequence requires additional steps to correct and the provision of the filter condition in selecting multi-taken sequences to allocated into the prediction circuitry can result in a lower likelihood that an incorrectly predicted multi-taken sequence will have to be corrected.

Particular configurations will now be described with reference to the figures.

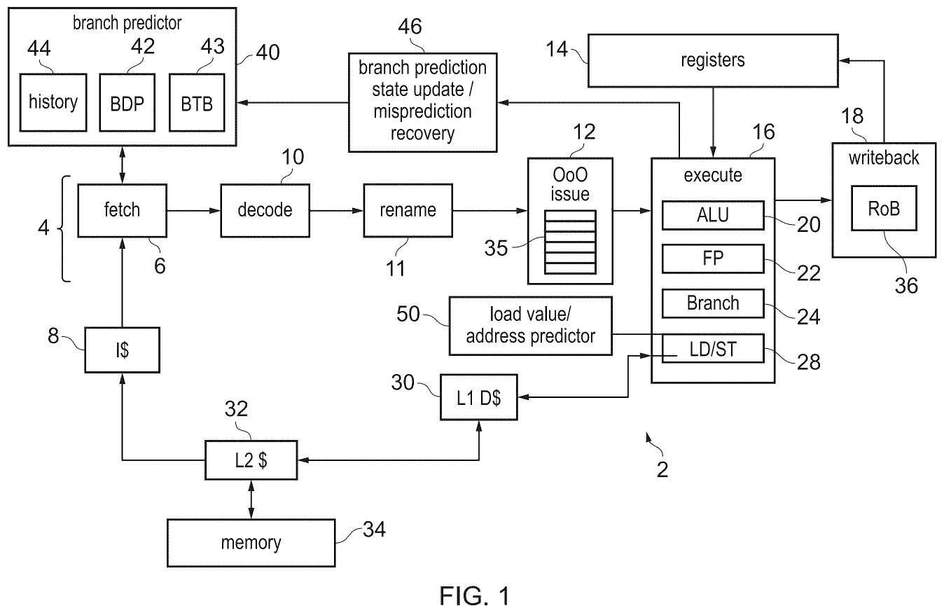

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; a register renaming stage 11 for mapping architectural registers specified by program instructions or micro-operations to physical register specifiers identifying physical registers in a register file 14; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

The processor shown in FIG. 1 is an out-of-order processor where the pipeline 4 includes a number of features supporting out-of-order processing. This includes the issue stage 12 having an issue queue 35 for queuing instructions and issue control circuitry which is able to issue a given instruction for execution if its operands are ready, even if an earlier instruction in program order has not issued yet. Also the writeback stage 18 may include a reorder buffer (ROB) 36 which tracks the execution and the commitment of different instructions in the program order, so that a given instruction can be committed once any earlier instructions in program order have themselves be committed. Also, the register renaming stage 11 helps to support out of order processing by remapping architectural register specifiers specifying the instructions decoded by the decode stage 10 to physical register specifiers identifying physical registers 14 provided in hardware. The instruction encoding may only have space for a register specifiers of a certain limited number of bits which may restrict the number of architectural registers supported to a relatively low number such as 16 or 32. This may cause register pressure, where after a certain number of instructions have been processed a later instruction which independent of an earlier instruction which references a particular register needs to reuse that register for storing different data values. In an in-order processor, that later instruction would need to wait until the earlier reference to the same register has completed before it can proceed, but these register dependencies caused by insufficient number of architectural registers can be avoided in an out-of-order processor by remapping the references to the same destination register in different instructions to different physical registers within the register file 14, which may comprise a greater number of physical registers than the number of architectural registers supported in the instruction encoding. This can allow a later instruction which writes to a particular architectural register to be executed while an earlier instruction which writes to the same architectural register is stalled, because those register references are mapped to different physical registers in the register file 14. It will be appreciated that other features may support out of order processing.

As shown in FIG. 1, the apparatus 2 has a number of prediction mechanisms for predicting instruction behaviour for instructions at particular instruction addresses. For example, these prediction mechanisms may include a branch predictor 40 and a load value or load address predictor 50. It is not essential for processors to have both forms of predictor. The load value or load address predictor is provided for predicting data values to be loaded in response to load instructions executed by the load/store unit 28 and/or predicting load addresses from which the data values are to be loaded before the operands for calculating the load addresses have been determined. For example, the load value prediction may record previously seen values loaded from a particular address, and may predict that on subsequent instances of loading from that address the value is expected to be the same. Also, the load address predictor may track history information which records observed stride patterns of address accesses (where the addresses of successive loads differ by a constant offset) and then use that observed stride pattern to predict the address of a future load instructions by continuing to add offsets to the latest seen address at intervals of the detected stride.

Also, the branch predictor 40 may be provided for predicting outcomes of branch instructions (otherwise referred to as control flow altering instructions), which are instructions which can cause a non-sequential change of program flow. Branches may be performed conditionally, so that they may not always be taken. The branch predictor is looked up based on addresses of instructions provided by the fetch stage 6, and provides a prediction of whether those instruction addresses are predicted to correspond to branch instructions. For any predicted branch instructions, the branch predictor provides a prediction of their branch properties such as a branch type, branch target address and branch direction (branch direction is also known as predicted branch outcome, and indicates whether the branch is predicted to be taken or not taken). The branch predictor 40 includes a branch target buffer (BTB) 43 for predicting properties of the branches other than branch direction, and a branch direction predictor (BDP) 42 for predicting the not taken/taken outcome of a branch (branch direction). It will be appreciated that the branch predictor could also include other prediction structures, such as a call-return stack for predicting return addresses for function calls, a loop direction predictor for predicting when a loop controlling instruction will terminate a loop, or other specialised types of branch prediction structures for predicting behaviour of branches in specific scenarios. In general, the BTB may act as a cache correlating particular instruction addresses with sets of one or more branch properties such as branch type or the branch target address (the address predicted to be executed next after the branch if the branch is taken), and may also provide a prediction of whether a given instruction address is expected to correspond to a branch at all.

The branch direction predictor 42 may be based on a variety of different prediction techniques, e.g. a TAGE predictor or a perceptron predictor, which includes prediction tables which track prediction state used to determine whether, if a given instruction address is expected to correspond to a block of instructions including a branch, whether that branch is predicted to be taken or not taken. The BDP 42 may base its prediction on history records (e.g., local history and/or global history) tracked in history storage circuitry 44. The history records will be discussed in more detail below, but in general they provide tracking of sequences of observed instruction behaviour for instructions whose instruction addresses map onto a particular subset of instruction addresses, with a number of separate history records being provided for different subsets of instruction addresses. This can be used for indexing into the prediction tables of the BDP 42 or in some cases to provide a direct prediction of the predicted branch behaviour.

The apparatus 2 may have branch prediction state updating circuitry and misprediction recovery circuitry 46, which updates state information within the branch predictor 40 based on observed instruction behaviour seen at the execute stage 16 for branch instructions executed by the branch unit 24. When a branch instruction is executed and the observed behaviour for the branch matches the prediction made by the branch predictor 40 (both in terms of whether the branch is taken or not and in terms of other properties such as branch target address) then the branch prediction state updating circuitry 46 may update prediction state within the BDP 42 or the BTB 43 to reinforce the prediction that was made so as to make it more confident in that prediction when that address is seen again later. Alternatively, if there was no previous prediction state information available for a given branch then when that branch is executed at the execute stage 16, its actual outcome is used to update the prediction state information. Similarly, the history storage 44 may be updated based on an observed branch outcome for a given branch.

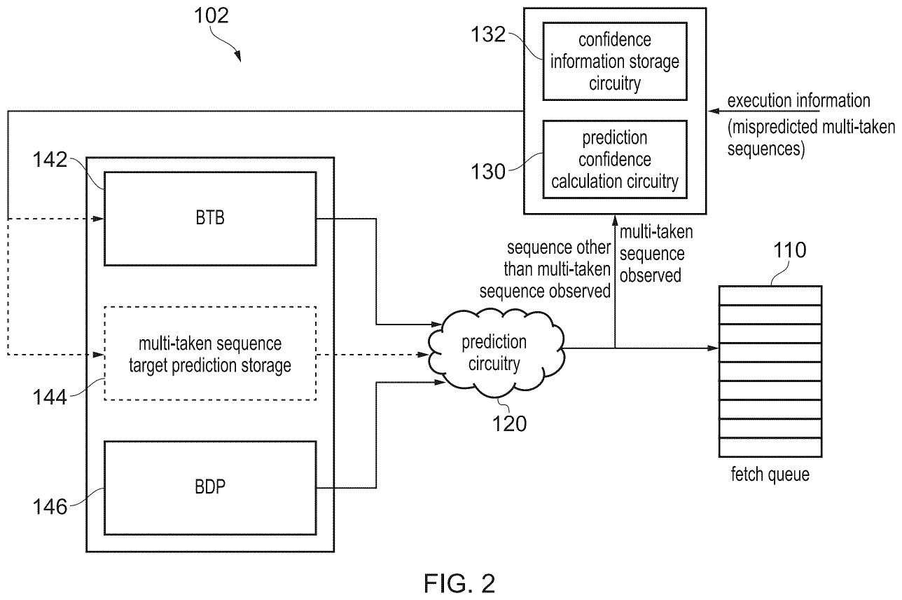

FIG. 2 is a schematic illustrating further detail of an apparatus 102 in accordance with some configurations of the present techniques. The apparatus 102 implements branch prediction to populate a fetch queue 110 (also referred to as a prediction address queue) with instruction addresses that are identify instructions to be fetched for execution by one or more execution units of the apparatus 102. Those addresses can be routed to an instruction cache (not shown) that retrieves the instructions at the identified addresses (if a hit is detected in the instruction cache for an input address, then the instruction can be output directly from the instruction cache, whereas otherwise the instruction can be requested from a lower level of a memory hierarchy forming the memory system and, when retrieved, can be output from the instruction cache). The fetched instructions are then forwarded to an instruction decoder where they are decoded in order to produce control signals used to control the operation of the execution units so as to implement the operations required by those instructions.

The apparatus 102 may be arranged during each prediction iteration to consider a predict block of instructions, where the predict block comprises a plurality of sequential instructions within the memory address space. The predict block may for example be identified by a start address identifying the first instruction address within the predict block, and the size of the predict block will typically be predetermined. For example, a 32 byte predict block may be considered in each prediction iteration, and in one particular implementation each instruction may have an instruction address formed of 4 bytes, such that each predict block represents eight instructions at sequential addresses in memory.

Each predict block predicted by the apparatus 102 is added into the fetch queue 110, whilst also being provided to various branch prediction mechanisms within the apparatus 102. The aim of the apparatus 102 is to predict whether any instructions identified by the predict block are control flow changing instructions that are predicted as taken. In the event that the predict block includes one or more of such instructions, then the location of the first control flow changing instruction that is predicted as taken is identified, and the target address of that control flow changing instruction is used to identify the start address for the next predict block. If no such control flow changing instructions are identified within the predict block, then the start address for the next predict block is merely the sequential address following the last address of the current predict block. When the branch predictor 110 predicts that a predict block does include a control flow changing instruction that is predicted as taken, then the position of that control flow changing instruction is used to modify the content of the predict block as added into the fetch queue 110. For example, if it is determined that the fourth instruction in the sequence of eight identified by a predict block is predicted as taken, then the final four instructions will be discarded from the sequence of instructions identified within the fetch queue 110, so that those later instructions are not fetched for execution by the execution circuitry, and instead the next instruction fetched after the fourth instruction in that predict block will be the instruction at the predicted target address for the control flow changing instruction (i.e. the first instruction in the next predict block).

The apparatus 102 can include a number of branch prediction components. As shown in FIG. 2, a branch direction predictor (BDP) 146 can be used for seeking to predict whether a conditional control flow changing instruction will be taken or not taken. If a control flow changing instruction is not taken, then the next instruction to be executed will be the instruction immediately following that control flow changing instruction in the instruction address space. However, if the control flow changing instruction is predicted as taken, then a determination of the target address for that instruction is required, as the next instruction that will be predicted to be executed will be the instruction at that target address.

To assist in the prediction of target addresses, one or more branch target buffer (BTB) structures may be provided. For example, as illustrated in FIG. 2, a BTB 142 is provided for making a prediction of the target address of a control flow changing instruction that is predicted as taken. Hence, for a control flow changing instruction that is predicted as taken, the BTB 142 can be used to assist in the determination of a target address for that control flow changing instruction. In particular, an entry may be provided for that control flow changing instruction, and may include information that is used to determine a predicted target address. That predicted target address may be encoded directly within the entry of the BTB, or alternatively a further target prediction structure may be referenced in order to predict the target address. For example, if the BTB 142 identifies that the branch instruction is a function return instruction, then the target address itself may not be identified within the BTB entry, but instead a return stack structure will be referred to in order to obtain the predicted target address.

The throughput of the apparatus 102 can effectively represent a bottleneck within the system. In particular, the fetch queue 110 may be able to receive multiple blocks of instructions in a single cycle, but the apparatus 102 itself may only be able to receive and process a single block of instructions in one cycle. In accordance with the techniques described herein, a mechanism is provided that enables multi-taken sequences to be populated in target prediction storage (either the BTB 142 or separately provided multi-taken sequence target prediction storage 144) to enable two blocks of instructions to be added into the fetch queue 110 in a single cycle.

To support this behaviour and so as to maintain the accuracy of prediction, prediction confidence calculation circuitry 130 is provided to monitor confidence levels associated with a plurality of multi-taken sequences in order to control which multi-taken sequences predictions should be allowed to be made.

In accordance with the techniques described herein, the prediction confidence calculation circuitry 130 maintains confidence information stored in confidence information storage circuitry 132 to identify multi-taken sequences and maintain an associated confidence level associated with such sequences. Based on execution information from execution circuitry (which may include instances of misprediction where a multi-taken sequence was incorrectly predicted, and observed sequences of instructions where multi-taken sequences are either taken or not taken), the prediction confidence calculation circuitry 130 updates the confidence information in the confidence information storage circuitry 132 to represent any resulting changes in the confidence levels.

Based on the confidence levels for the multi-taken sequences, the prediction confidence circuitry allocates (populates) and invalidates entries in the target prediction storage for multi-taken sequences (which may be implemented as dedicated multi-taken sequence target prediction storage 144 or may be implemented as part of the BTB 142). Prediction circuitry 120 is provided to make determinations, based on the prediction components (including the BTB 142, the multi-taken sequence target prediction storage 144 if provided, and the branch direction predictor 146) about which predictions should be made and so how to populate the fetch queue 110. Hence, by altering which indications of multi-taken sequences are stored in the target prediction storage 142, 144, the prediction confidence calculation circuitry is able to control whether the prediction circuitry 120 is allowed to predict particular multi-taken sequences.

In this way, the prediction confidence calculation circuitry 130 is able to allow the prediction circuitry 120 to make predictions of multi-taken sequences, even when it is not known for certain whether the multi-taken sequence will turn out to be executed as predicted, whilst maintaining a high level of accuracy so as to reduce the incidence of mispredictions.

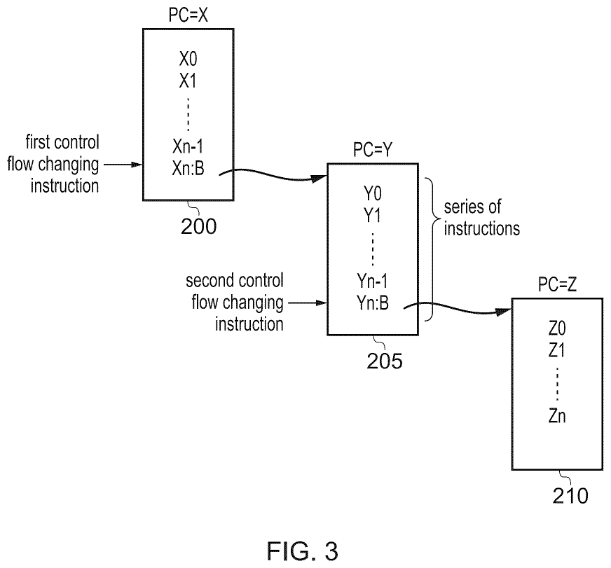

FIG. 3 schematically illustrates an example multi-taken sequence of the form that may be predicted using the apparatus 102 of FIG. 2. In this instance, a first predict block X 200 is assumed to contain a control flow changing instruction, having address Xn, that is predicted as taken and that results in the identification of a target address identifying the next predict block Y 205. This second predict block Y terminates with a control flow changing instruction that branches to the predict block Z 210. In such situations, it has been found possible to create an entry within target prediction circuitry 142, 144 that identifies as a first control flow changing instruction the branch instruction within the predict block X 200, along with an indication of the associated target address Y0, and in addition captures sufficient information about the predict block Y 205 and the resulting target address ZO to enable both the predict blocks Y 205 and Z 210 to be added directly into the fetch queue, but with the next prediction iteration starting with the predict block Z 210.

Control flow changing instructions can be categorised into two types, namely those exhibiting dynamic behaviour and those exhibiting static behaviour. Dynamic behaviour instructions change their behaviour dependent on the status of the processor executing those instructions. Hence, dynamic control flow changing instructions include any form of conditional branch instruction, since a direction prediction is required in order to determine whether the branch will be taken or not taken, and typically an assessment of certain condition flags of the processor is required in order to determine whether the control flow changing instruction will be taken or not. As another example of a dynamic behaviour branch instruction, polymorphic indirect branches will also be considered to exhibit dynamic behaviour, since typically the target address will depend on the contents of at least one general purpose register, and those contents will vary between instances where that indirect branch instruction is executed.

Static behaviour branch instructions are then the remaining branch types. Hence, any unconditional direct control flow changing instruction will be considered to exhibit static behaviour, since it will always be taken, and the target address can be determined directly from the branch instruction itself, and hence does not vary each time the unconditional direct branch instruction is executed. Also, for the purposes of the techniques described herein, unconditional function return instructions can be considered to exhibit static behaviour since, despite the fact that the target address can vary (for example due to different function call instructions being associated with the same function return instruction), the target address is predictable in that it can be obtained from a return stack structure.

In some configurations, multi-taken sequences exhibiting static behaviour, (i.e., for which the second control flow changing instruction has static behaviour and none of the series of instructions occurring earlier in the predict block Y 205 than the second control flow changing instruction Yn are control flow changing instructions) are predicted. This may be done to ensure accuracy of prediction since if the first control flow changing instruction is correctly predicted (e.g., using existing prediction structures) it will be known that the multi-taken sequence will proceed as predicted.

In addition, in some configurations, as well as predicting multi-taken sequences that exhibit static behaviour, multi-taken sequences that exhibit dynamic behaviour can be predicted. Thus, multi-taken sequences having as their second control flow changing instruction a conditional control flow changing instruction and multi-taken sequences having additional control flow changing instructions in the series of instructions can be predicted. This can therefore increase the rate at which predictions can be made, with the prediction confidence calculation circuitry 130 operating to ensure that a desired level of prediction accuracy is maintained.

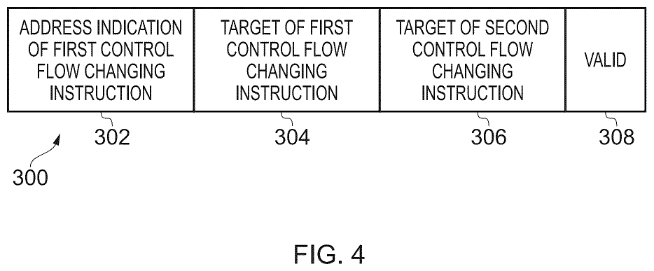

FIG. 4 illustrates a target prediction entry 300 used to store an indication of a multi-taken sequence for reference by the prediction circuitry 120. As illustrated, the entry comprises an address indication of a first control flow changing instruction to identify the address of either a first control flow changing instruction or a predict block containing such a first control flow changing instruction. The entry 300 also identifies a target of the first control flow changing instruction 304 and a target of the second control flow changing instruction 306. Based on this information, the prediction circuitry 120 can cause the predict blocks containing the targets of the first and second control flow changing instructions respectively to be identified in the fetch queue 110. The target prediction entry 300 also comprises a valid indicator 308 to indicate whether the target prediction entry 300 is a valid entry upon which a prediction can be based. This may be implemented as a single bit having a first value (e.g., zero) to indicate that the entry is valid and can be used by the prediction circuitry 20 to make predictions and a second value (e.g., one) to indicate that the entry is invalid and so should not be used as the basis of predictions. Thus, to prevent the multi-taken sequence being predicted by the prediction circuitry 120, the prediction calculation circuitry 130 can set the valid indicator to the second value, thereby preventing the multi-taken sequence associated with the entry 300 being predicted.

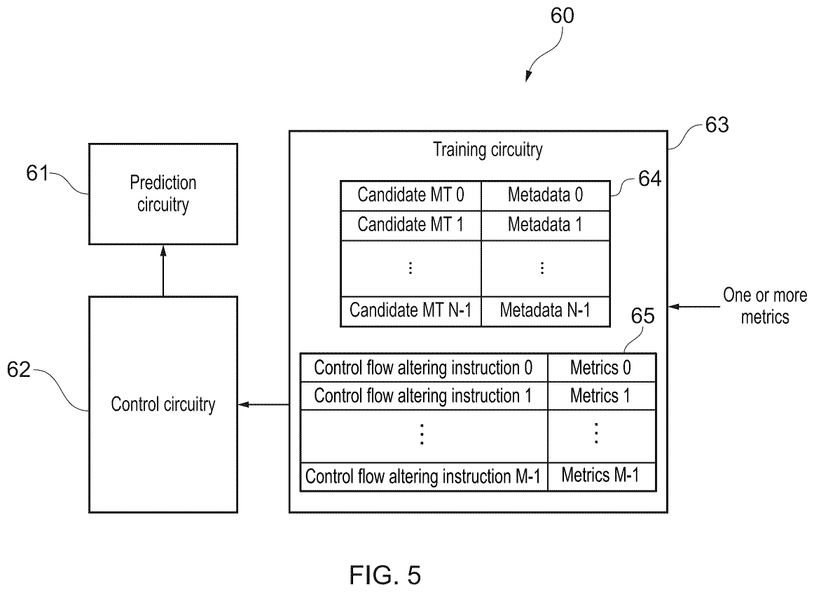

FIG. 5 schematically illustrates an apparatus 60 according to some configurations of the present techniques. The apparatus 60 is provided with prediction circuitry 61, control circuitry 62, and training circuitry 63. The prediction circuitry may comprise the branch target buffer 142 and/or the multi-taken sequence target prediction storage 144 as described in relation to FIG. 2. The prediction circuitry 61 is configured to predict control flow based on stored prediction entries, for example, in response to receipt of a program counter value associated with the prediction entries.

The training circuitry 63 is configured to store a plurality of candidate multi taken entries 64. Each of the candidate multi-taken entries 64 identifies a multi-taken sequence, for example, a multi-taken sequence of the form illustrated in relation to FIG. 3. Each of the candidate multi-taken entries 64 also stores metadata indicative of a confidence associated with the candidate multi-taken sequence. The training circuitry also stores one or more metrics 65 for each of a plurality of control flow altering instructions. The control flow altering instructions may be identified, for example, based on a program counter value of the control flow altering instruction.

The control circuitry 62 is provided to determine which of the multi-taken entries 64 are to be allocated into the prediction circuitry 61. The determination of which of the multi-taken entries 64 are to be allocated is based on the metadata associated with each of the multi-taken entries 64 and the metrics 65 associated with the control flow altering instructions associated with those multi-taken entries. In particular, the control circuitry is configured to identify entries of the candidate multi-taken entries 64 for which both the confidence satisfies a confidence condition, and the one or more metrics associated with the control flow altering instructions satisfy a filter condition. When the control circuitry 62 identifies an entry for which both the confidence condition and the filter condition are satisfied, the control circuitry 62 triggers the candidate multi-taken entry to be allocated as a prediction entry in the prediction circuitry 61.

The one or more metrics 65 associated with each of the control flow altering instruction are updated when the control flow altering instruction is identified as being predicted by the prediction circuitry 61. For example, a control flow altering instruction having a particular program counter value may be encountered during execution of instructions and the prediction circuitry may make a prediction for that single control flow altering instruction. When the prediction is made and/or when the prediction is resolved the training circuitry may identify metadata associated with that control flow altering instruction based on the particular program counter value and the one or more metrics associated with that control flow altering instruction may be updated.

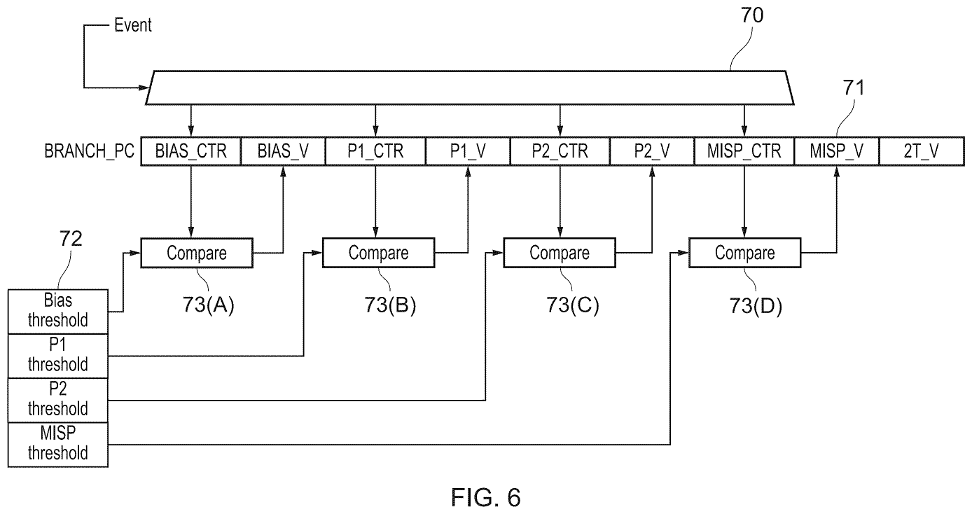

FIG. 6 schematically illustrates the storage of one or more metrics 71 as part of the metadata associated with a branch instruction. The one or more metrics 71 are stored in addition to the confidence for that branch instruction and are identified based on a program counter value of a the branch instruction (BRANCH_PC). The one or more metrics 71 may be include a bias counter (BIAS_CTR) which is incremented in response to event information identifying that a branch has been taken and decremented otherwise, a first prediction circuit counter (P1_CTR) which is incremented in response to event information identifying a branch is predicted using a first branch prediction structure and decremented otherwise, a second prediction circuit counter (P2_CTR) which is incremented in response to event information identifying each time a branch is predicted using a second prediction circuit and decremented otherwise, and a misprediction counter (MISP_CTR) which is incremented in response to event information identifying a branch misprediction and decremented otherwise. For each of the counters the amount by which a counter is incremented in response to an event may be different to the amount by which a counter is decremented in response to an absence of that event. It will be readily apparent to the person of ordinary skill in the art that the first prediction circuit and the second prediction circuit could be any type of branch prediction circuit, for example, the branch prediction circuits mentioned in reference to FIG. 1.

The one or more metrics 71 also includes a plurality of persistent fields which are set once a respective counter reaches a corresponding one of a plurality of thresholds 72. In the illustrated configuration the thresholds 72 include a bias threshold, a first predictor (P1) threshold, a second predictor (P2) threshold, and a MISP threshold. The bias threshold and the bias counter are provided to comparison circuitry 73(A) and when it is identified that the BIAS counter meets the bias threshold, then the comparison circuitry 73(A) triggers the bias persistent bit (BIAS_V) to be set. The P1 threshold and the P1 counter are provided to comparison circuitry 73(B) and when it is identified that the P1 counter meets the P1 threshold, then the comparison circuitry 73(B) triggers the P1 persistent bit (P1_V) to be set. The P2 threshold and the P2 counter are provided to comparison circuitry 73(C) and when it is identified that the P2 counter meets the P2 threshold, then the comparison circuitry 73(C) triggers the bias persistent bit (P2_V) to be set. The MISP threshold and the MISP counter are provided to comparison circuitry 73(D) and when it is identified that the MISP counter meets the MISP threshold, then the comparison circuitry 73(D) triggers the bias persistent bit (MISP_V) to be set.

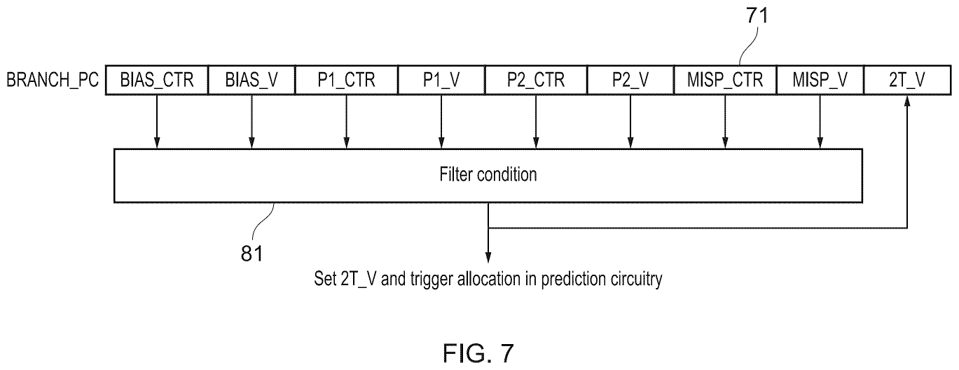

The one or more metrics also includes a persistent value to indicate when the filter condition has been satisfied (2T_V) for that branch instruction based on a combination of the one or more metrics 71, i.e., whether multi-taken entries using that branch instruction can be allocated into the prediction circuitry to be used to predict multi-taken sequences. FIG. 7 schematically illustrates setting of the persistent value 2T_V. In the illustrated configuration each of the one or more metrics 71 is provided to a filter circuit 81 implementing a filter condition. The filter circuit 81 determines if the values in of the one or more metric meet the filter condition and, when it is determined that the one or more metrics 71 meet the filter condition, the persistent value 2T_V is set and the candidate multi-taken entry is allocated into the prediction circuitry. The persistent values may remain set for an observation window, for example, a window defined as being a number of cycles or instructions. The filter condition may be based on any logical combination of the one or more metrics 71 and may use all or only a subset of the values. For example, the filter condition may be satisfied when BIAS_V && !P1_V && !P2_V &&!MISP_V is satisfied (here && is used to denote a logical AND function and ! is used to denote a logical NOT function). In other words, when the bias counter has reached a threshold and each of the P1 counter, the P2 counter, and the misprediction counter have not reached their respective thresholds, then the filter condition may be satisfied. It will be readily apparent to the person of ordinary skill in the art that the stored one or more metrics 71 are provided by way of example and that other metrics could be stored. Similarly, the above filter condition is provided as an example, and other filter conditions may be provided, for example, dependent on the prediction structures provided in the apparatus.

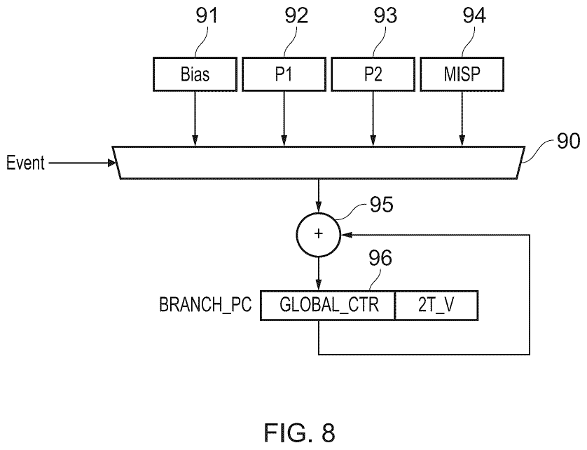

FIG. 8 schematically illustrates a further example of storing one or more metrics 96 associated with a branch instruction. The branch instruction is identified, for example, by a program counter value associated with the control flow altering instructions. Rather than storing a plurality of counters (for example, as described in relation to FIGS. 6 and 7) the one or more metrics 96 are stored as a single global counter (GLOBAL_CTR) and a persistent value 2T_V which is set once the global counter meets the filter condition and is used to identify when a branch instruction can be included within a multi-taken sequence. The selection circuitry 90 receives event information which identifies whether or not a branch is taken, whether or not a branch is predicted using a first prediction structure, whether or not a branch is predicted by a replay predictor, and whether or not the branch is mispredicted. Dependent on the event information, an appropriate amount to increment or decrement the global counter by may be provided. For example, when the event information indicates that a branch is taken, the selection circuitry 90 passes a bias modifier 91 (otherwise referred to as a bias weight) to accumulation circuitry 95 to be accumulated with a current value of the global counter stored as the one or more metrics 96. When the event information indicates that the first prediction structure has been used to make the prediction, the selection circuitry 90 passes a first prediction modifier 92 (otherwise referred to as a P1 weight) to accumulation circuitry 95 to be accumulated with a current value of the global counter stored as the one or more metrics 96. When the event information indicates that the second prediction structure has been used to make the prediction, the selection circuitry 90 passes a P2 modifier 93 (otherwise referred to as an P2 weight) to accumulation circuitry 95 to be accumulated with a current value of the global counter stored as the one or more metrics 96. When the event information indicates that an misprediction has occurred, the selection circuitry 90 passes a misprediction modifier 94 (otherwise referred to as a misprediction weight) to accumulation circuitry 95 to be accumulated with a current value of the global counter stored as the one or more metrics 96. It will be readily apparent to the skilled person that the bias modifier 91, the P1 modifier 92, the P2 modifier 93 and the misprediction modifier 94 may be signed values with the bias modifier having a different sign to the P1, P2 and misprediction modifiers. Furthermore, multiple modifiers may be accumulated into the global counter for each occurrence of a branch. In addition, it will be readily apparent that multiple modifiers could be provided for each event. For example, a BIAS increment and a different BIAS decrement could be provided with the BIAS increment being accumulated into the global counter when a branch is taken and the BIAS decrement being accumulated when the branch is not taken.

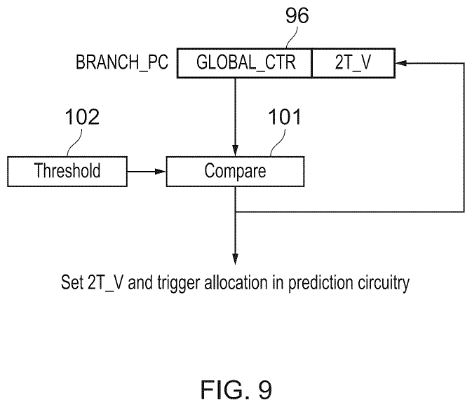

FIG. 9 schematically illustrates the use of the one or more metrics 96 to determine whether to trigger allocation of a candidate multi-taken entry comprising the branch instruction into the prediction circuitry. The global counter value in the one or more metrics 96 is passed to comparison circuitry 101 where it is compared against a threshold 102. When the comparison circuitry 101 identifies that the global counter has met the threshold 102, then the comparison circuitry 101 triggers the persistent value 2T_V to be set to enable allocation of a candidate multi-taken sequence that comprises the branch instruction into the prediction circuitry.

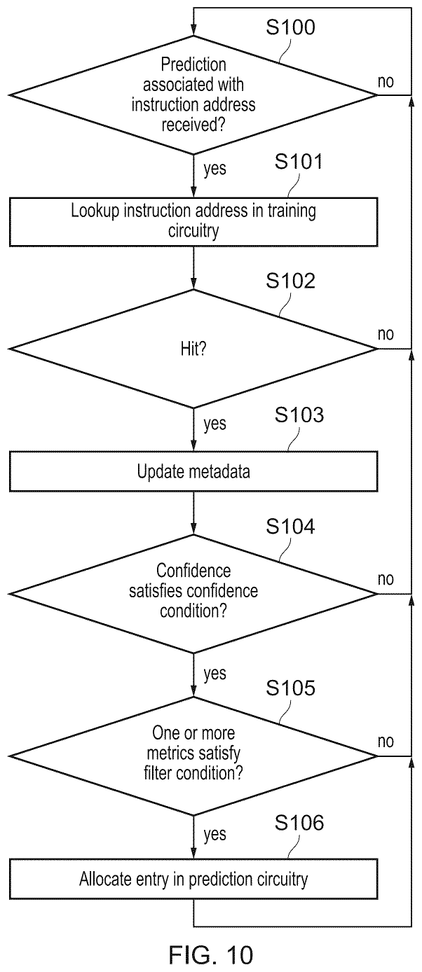

FIG. 10 schematically illustrates a sequence of steps carried out according to some configurations of the present techniques. Flow begins at step S100 where it is determined if a prediction associated with an instruction address has been received. If, at step S100, it is determined that a prediction associated with an instruction address has not been received, then flow remains at step S100. If, at step S100, it is determined that a prediction associated with an instruction address has been received, then flow proceeds to step S101 where a lookup is performed in the training circuitry based on the instruction address. Flow then proceeds to step S102 where it is determined if the lookup in the training circuitry resulted in a hit. If, at step S102, it is determined that the lookup did not result in a hit in the training circuitry, then flow returns to step S100. If, at step S102, it is determined that the lookup resulted in a hit in the training circuitry, then flow proceeds to step S103. At step S103, the metadata associated with the entry that resulted in the hit is updated. Flow then proceeds to step S104 where it is determined if the confidence associated with the entry that resulted in the hit satisfies a confidence condition. If, at step S104, it is determined that the confidence condition is not satisfied, then flow returns to step S100. If, at step S104, it is determined that the confidence condition is satisfied, then flow proceeds to step S105 where it is determined whether one or more metrics associated with the entry that resulted in the hit satisfy a filter condition. If, at step S105, it is determined that the one or more metrics do not satisfy the filter condition, then flow returns to step S100. If, at step S106, it is determined that the one or more metrics satisfy the filter condition, then flow proceeds to step S106. At step S106, the entry that resulted in the hit in the training circuitry is allocated as a prediction entry in the prediction circuitry before flow returns to step S100.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

As shown in FIG. 10, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising training circuitry to store one or more metrics associated with each of a plurality of control flow altering instructions, and a plurality of candidate multi-taken entries. Each candidate multi-taken entry identifies: a multi-taken sequence in which control flow is diverted by a first control flow altering instruction to instructions comprising a second control flow altering instruction that diverts control flow to a target address, and metadata indicative of a confidence associated with the candidate multi-taken sequence. The apparatus comprises control circuitry responsive to the confidence associated with a given candidate multi-taken entry satisfying a confidence condition and the metrics associated with at least one of the first and second control flow altering instructions of the given candidate multi-taken entry satisfying a filter condition, to allocate a prediction entry indicative of the multi-taken sequence identified in the given candidate multi-taken entry into prediction circuitry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
training circuitry configured to store one or more metrics associated with each of a plurality of control flow altering instructions, and a plurality of candidate multi-taken entries, each of the candidate multi-taken entries identifying:
   a multi-taken sequence of instructions in which control flow is diverted by a first control flow altering instruction to a series of instructions comprising a second control flow altering instruction that diverts control flow to a target address; and
   metadata indicative of a confidence associated with the candidate multi-taken sequence; and
control circuitry responsive to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, to allocate a prediction entry indicative of the multi-taken sequence identified in the given candidate multi-taken entry into prediction circuitry configured to predict control flow based on the prediction entry.

Clause 2. The apparatus of clause 1, wherein the one or more metrics comprise information other than the confidence.

Clause 3. The apparatus of clause 1 or clause 2, wherein the one or more metrics comprise at least one exclusive metric, and the control circuitry is responsive to the at least one exclusive metric associated with at least one of the first control flow altering instruction and the second control flow altering instruction of the given candidate multi-taken entry meeting an exclusion condition, to exclude the given candidate multi-taken sequence from allocation into the prediction circuitry.

Clause 4. The apparatus of any preceding clause, wherein the training circuitry is configured to store the one or more metrics in a plurality of fields, and the control circuitry is configured to calculate whether the filter condition is satisfied based on a combination of the plurality of fields.

Clause 5. The apparatus of clause 4, wherein the combination of the plurality of fields is dynamically configurable.

Clause 6. The apparatus of clause 4 or clause 5, wherein the combination comprises at least one of:
an arithmetic combination of the plurality of fields; and
a logical combination of the plurality of fields.

Clause 7. The apparatus of any of clauses 4 to 6, wherein at least one of the plurality of fields is configured to increment in response to a first event and to decrement in response to a second event.

Clause 8. The apparatus of any preceding clause, wherein the training circuitry is configured to store the one or more metrics in a combined metric field indicative of a combination of the one or more metrics.

Clause 9. The apparatus of clause 8, wherein:
the combined metric field is a global metric field; and
the training circuitry is configured to update the global metric field in response to a change in each of the one or more metrics.

Clause 10. The apparatus of clause 8 or clause 9, wherein:
the training circuitry table is configured to store a plurality of weights, each of the plurality of weights associated with one of the one or more metrics; and
the training circuitry is responsive to a given event corresponding to one of the one or more metrics of an associated control flow altering instruction, to select a given weight associated with the given event from the plurality of weights, and to modify the combined metric field of the associated control flow altering instruction by an amount indicated by the given weight.

Clause 11. The apparatus of any of clauses 8 to 10, wherein the combined metric field is indicative of the confidence.

Clause 12. The apparatus of any preceding clause, wherein the one or more metrics comprises at least one prediction structure metric indicative of a type of prediction structure used to determine control flow resulting from an associated control flow altering instruction.

Clause 13. The apparatus of any preceding clause, wherein the one or more metrics comprises at least one prediction accuracy metric indicative of a misprediction rate associated with an associated control flow altering instruction.

Clause 14. The apparatus of any preceding clause, wherein:
the one or more metrics comprises one or more persistent fields, each of the one or more persistent fields associated with a different one of the one or more metrics; and
the training circuitry is responsive to a given metric of the one or more metrics meeting a predefined condition, to set the persistent field associated with the given metric.

Clause 15. The apparatus of clause 14, wherein the training circuitry is configured to maintain a set value of the one or more persistent fields throughout a training window having a predefined training window duration.

Clause 16. The apparatus of any preceding clause comprising:
a fetch queue configured to identify a sequence of instructions to be fetched for execution; and
the prediction circuitry, wherein the prediction circuitry is configured to store a plurality of prediction entries, and in response to receipt of an instruction address, to perform a lookup in the prediction storage circuitry based on the instruction address, and when the lookup results in a hit on a given entry in the prediction storage circuitry, to perform a prediction of upcoming control flow based on the given entry and to control which instructions are identified in the fetch queue in dependence on the prediction.

Clause 17. A system comprising:
the apparatus of any preceding clause, implemented in at least one packaged chip;
at least one system component; and
a board,
wherein the at least one packaged chip and the at least one system component are assembled on the board.

Clause 18. A chip-containing product comprising the system of clause 17, wherein the system is assembled on a further board with at least one other product component. Clause 19. A method comprising:
storing, in training circuitry, one or more metrics associated with each of a plurality of control flow altering instructions, and a plurality of candidate multi-taken entries, each of the candidate multi-taken entries identifying:
   a multi-taken sequence of instructions in which control flow is diverted by a first control flow altering instruction to a series of instructions comprising a second control flow altering instruction that diverts control flow to a target address; and
   metadata indicative of a confidence associated with the candidate multi-taken sequence; and
in response to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, allocating a prediction entry indicative of the multi-taken sequence identified in the given candidate multi-taken entry into prediction circuitry configured to predict control flow based on the prediction entry.

Clause 20. A non-transitory computer-readable medium storing computer-readable code for fabrication of the apparatus of any of clauses 1 to 16.

We claim:

1. An apparatus comprising:
training circuitry configured to store one or more metrics associated with each of a plurality of control flow altering instructions, and a plurality of candidate multi-taken entries, each of the candidate multi-taken entries identifying:
a multi-taken sequence of instructions in which control flow is diverted by a first control flow altering instruction to a series of instructions comprising a second control flow altering instruction that diverts control flow to a target address; and
metadata indicative of a confidence associated with the candidate multi-taken sequence; and
control circuitry responsive to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, to allocate a prediction entry indicative of the multi-taken sequence identified in the given candidate multi-taken entry into prediction circuitry configured to predict control flow based on the prediction entry.

2. The apparatus of claim 1, wherein the one or more metrics comprise information other than the confidence.

3. The apparatus of claim 1, wherein the one or more metrics comprise at least one exclusive metric, and the control circuitry is responsive to the at least one exclusive metric associated with at least one of the first control flow altering instruction and the second control flow altering instruction of the given candidate multi-taken entry meeting an exclusion condition, to exclude the given candidate multi-taken sequence from allocation into the prediction circuitry.

4. The apparatus of claim 1, wherein the training circuitry is configured to store the one or more metrics in a plurality of fields, and the control circuitry is configured to calculate whether the filter condition is satisfied based on a combination of the plurality of fields.

5. The apparatus of claim 4, wherein the combination of the plurality of fields is dynamically configurable.

6. The apparatus of claim 4, wherein the combination comprises at least one of:
an arithmetic combination of the plurality of fields; and
a logical combination of the plurality of fields.

7. The apparatus of claim 4, wherein at least one of the plurality of fields is configured to increment in response to a first event and to decrement in response to a second event.

8. The apparatus of claim 1, wherein the training circuitry is configured to store the one or more metrics in a combined metric field indicative of a combination of the one or more metrics.

9. The apparatus of claim 8, wherein:
the combined metric field is a global metric field; and
the training circuitry is configured to update the global metric field in response to a change in each of the one or more metrics.

10. The apparatus of claim 8, wherein:
the training circuitry table is configured to store a plurality of weights, each of the plurality of weights associated with one of the one or more metrics; and
the training circuitry is responsive to a given event corresponding to one of the one or more metrics of an associated control flow altering instruction, to select a given weight associated with the given event from the plurality of weights, and to modify the combined metric field of the associated control flow altering instruction by an amount indicated by the given weight.

11. The apparatus of claim 8, wherein the combined metric field is indicative of the confidence.

12. The apparatus of claim 1, wherein the one or more metrics comprises at least one prediction structure metric indicative of a type of prediction structure used to determine control flow resulting from an associated control flow altering instruction.

13. The apparatus of claim 1, wherein the one or more metrics comprises at least one prediction accuracy metric indicative of a misprediction rate associated with an associated control flow altering instruction.

14. The apparatus of claim 1, wherein:
the one or more metrics comprises one or more persistent fields, each of the one or more persistent fields associated with a different one of the one or more metrics; and
the training circuitry is responsive to a given metric of the one or more metrics meeting a predefined condition, to set the persistent field associated with the given metric.

15. The apparatus of claim 14, wherein the training circuitry is configured to maintain a set value of the one or more persistent fields throughout a training window having a predefined training window duration.

16. The apparatus of claim 1 comprising:
a fetch queue configured to identify a sequence of instructions to be fetched for execution; and
the prediction circuitry, wherein the prediction circuitry is configured to store a plurality of prediction entries, and in response to receipt of an instruction address, to perform a lookup in the prediction storage circuitry based on the instruction address, and when the lookup results in a hit on a given entry in the prediction storage circuitry, to perform a prediction of upcoming control flow based on the given entry and to control which instructions are identified in the fetch queue in dependence on the prediction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
storing, in training circuitry, one or more metrics associated with each of a plurality of control flow altering instructions, and a plurality of candidate multi-taken entries, each of the candidate multi-taken entries identifying:
a multi-taken sequence of instructions in which control flow is diverted by a first control flow altering instruction to a series of instructions comprising a second control flow altering instruction that diverts control flow to a target address; and
metadata indicative of a confidence associated with the candidate multi-taken sequence; and
in response to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, allocating a prediction entry indicative of the multi-taken sequence identified in the given candidate multi-taken entry into prediction circuitry configured to predict control flow based on the prediction entry.

20. A non-transitory computer-readable medium storing computer-readable code for fabrication of an apparatus comprising:
training circuitry configured to store one or more metrics associated with each of a plurality of control flow altering instructions, and a plurality of candidate multi-taken entries, each of the candidate multi-taken entries identifying:
a multi-taken sequence of instructions in which control flow is diverted by a first control flow altering instruction to a series of instructions comprising a second control flow altering instruction that diverts control flow to a target address; and
metadata indicative of a confidence associated with the candidate multi-taken sequence; and
control circuitry responsive to both of the confidence associated with a given candidate multi-taken entry satisfying a confidence condition and the one or more metrics associated with at least one of the first control flow altering instruction and the second control flow altering instruction of the given candidate multi-taken entry satisfying a filter condition, to allocate a prediction entry indicative of the multi-taken sequence identified in the given candidate multi-taken entry into prediction circuitry configured to predict control flow based on the prediction entry.
